(19) United States
(12) Patent Application Publication
(10) Pub. No.: US 2016/0238538 A1
(43) Pub. Date: Aug. 18, 2016

(54) DIAGNOSTIC APPARATUS FOR CAPTURING MEDICAL SPECIMEN IMAGE

(71) Applicant: SIEMENS HEALTHCARE DIAGNOSTICS INC., Tarrytown, NY (US)

(72) Inventors: Ying Chi, Beijing (CN); Han Huang, Beijing (CN); Zhi Yuan Zhang, Beijing (CN); Jie Zou, Beijing (CN)

(73) Assignee: Siemens Healthcare Diagnostics Inc., Tarrytown, NY (US)

(21) Appl. No.: 15/024,214

(22) PCT Filed: Sep. 22, 2014
(86) PCT No.: PCT/US14/56770

§ 371 Date: Mar. 23, 2016

(30) Foreign Application Priority Data
Sep. 23, 2013 (CN) 201310435176.5

(51) Int. Cl. G01N 21/78; H04N 5/225; G02B 13/00; H04N 5/247

(52) U.S. Cl. CPC G01N 21/78; H04N 5/247; H04N 5/2252; G02B 13/0085; G01N 2201/062; G01N 2201/12; G01N 2021/7759

(57) ABSTRACT

The present invention provides a portable diagnostic apparatus for capturing a medical image. The apparatus includes a cavity for accommodating a medical specimen to be detected, a white light source, and multiple digital camera units for photographing the specimen to be detected. The camera units each include optics with positive refractive power and an image sensor smaller than ⅓ inches. The portable diagnostic apparatus can detect a change in color according to a captured digital image. The diagnostic apparatus can capture images of multiple reaction areas of a medical specimen at a time and in addition, the diagnostic apparatus is small in size and low in cost, captures images of high quality, and can provide more detailed information of the medical specimen being detected.

### PRIORITY STATEMENT

This application claims benefit under 35 U.S.C. §119 of Chinese Patent Application Number CN 201310435176.5 filed Sep. 23, 2013, the entire contents of which are hereby incorporated herein by reference.

### 1. FIELD OF THE INVENTION

The present invention relates to detection of medical specimen (including urine, blood, saliva, sweat, and other biological specimens), and in particular, to a portable diagnostic apparatus for capturing images of medical specimens.

### 2. BACKGROUND OF THE INVENTION

Medical specimen detection involves making use of a change in color. This manner usually uses a dip type strip (such as a urine test strip, a pregnancy test strip, and a blood glucose test strip), and the strip has multiple reagent reaction areas. Each reagent reaction area has a compound which can change color when a specific reactant is present. A conventional strip can detect blood glucose, bilirubin, ketone, pondus hydrogenii value (PH value), protein, occult blood, and the like. When a strip is used, the reaction area is in contact with a medical specimen such as urine, blood, saliva, and sweat. Urine analysis has become a commonly-used detection tool in medical diagnosis, and can detect substance or cell components in the urine, associated with metabolism disorders and kidney diseases. For example, before a patient realizes a disease, substances such as protein or glucose may present in urine.

A user, for example, a doctor and a patient previously observes usually in naked eyes the change in color before and after a strip contacts a medical specimen. A Chinese Patent Application No. CN102483401A (publication date being May 30, 2012) discloses a portable digital reader for urine analysis. It can be seen from FIG. 1 of the patent application, the portable digital reader uses a three-color light emitting diode (LED) as a light source. Light of the light source is cast on a biochip for detection, a silicon sensor (may be a silicon photoelectric diode or a photo triode) is used to analyze intensity and color of light reflected by the biochip, and the portable digital reader further includes a light splitter (that is, a photoconductor). The reader has the following two defects. First, the detection area of a silicon sensor is limited. For example, a standard reaction area of a urine strip is 5 mm×5 mm, reaction may take place in the entire reaction area of the strip, but the sensing area of a silicon sensor is usually smaller than 2 mm×2 mm. Therefore, a silicon sensor cannot detect the entire reaction area. In some cases, for example, in a case where only a local area of the reaction area reacts, the detection result of the reader may be false. In addition, a silicon sensor can only provide an average value of light intensities, but cannot show distribution of light in the reaction area, which limits the application of the reader. For example, for Occult Blood (OB), the density of the Occult Blood in the entire reaction area needs to be known, but the reader cannot provide accurate information of the density in a reaction area. Second, using a three-color LED increases the cost, and the use of a light splitter not only increases the cost, but also increases the size of the reader.

### SUMMARY OF THE INVENTION

In view of the above, the present invention in one aspect provides a portable diagnostic apparatus for capturing a medical image. The apparatus includes a cavity for accommodating a medical specimen to be detected, a white light source, and multiple digital camera units for photographing the specimen to be detected. Each of the camera units includes optics with positive refractive power and an image sensor smaller than ⅓ inches. The portable diagnostic apparatus provided in the present invention can detect a change in color according to the captured digital image. According to one aspect of the invention, the image sensor is a wafer-level image sensor. The wafer-level image sensor is simple in structure and small in size, and it enables convenient uses and does not need an electrical relay circuit. In addition, the cost of the wafer-level image sensor is low.

According to one aspect of the invention, the optics are wafer-level optics processed and formed by wafer-level package. The wafer-level package enables the optics to have a small size, a reliable performance, and a low production cost.

According to one aspect of the invention, the medical specimen to be detected is a urine strip. Urine detection has a wide application, so that the diagnostic apparatus of the present invention may be used for detecting a urine test strip. Currently, a standard urine test strip is about 11 cm in length, three digital camera units are used which and arranged in a lengthwise direction of the urine strip. A relationship between the focal length of the optics of the digital camera units and the object distance meets the following requirements that the focal length of the optics divided by an object distance is smaller than 0.08. Using the digital camera units to detect a urine test strip not only captures high quality images, but also may reduce the size and the production cost of the diagnostic apparatus due to the small number of digital camera units. The white light source may be one or more semiconductor LEDs. For a specimen with the length like that of a urine test strip, a pregnancy test strip, a blood glucose test strip, one single light source is enough for the camera units to capture an acceptable image, so that the diagnostic apparatus is small in size and low in cost. However, the use of two or more light sources allows the light to be cast uniformly on the medical specimen to be detected, thereby capturing an image of extremely high quality.

According to one aspect of the invention, the diagnostic apparatus further includes one or more reflectors for turning optical paths, so as to reduce the size of the diagnostic apparatus. One or more reflectors helps to shorten distances between the camera units and the specimen, and the camera units may capture virtual images formed by the reflectors.

According to one aspect of the invention, the digital camera unit further includes a printed circuit board (PCB) disposed below the image sensor, so that images captured by the image sensor may be delivered through the PCB to subsequent apparatuses for processing, storing, and the like.

According to one aspect of the invention, the diagnostic apparatus further includes a shell, in which the cavity, the light source and the digital camera units are all disposed.

According to one aspect of the invention, the cavity is provided with a moving component that is movable relative to the shell, and the moving component can be moved out of the shell, so that a user can put the medical specimen to be detected on the moving component. By using a moving component that can be moved in and out of the shell, a medical specimen to be detected may be easily put in and taken out of the diagnostic apparatus by a user.

According to one aspect of the invention, the image sensor is 1/13 inches. Using an image sensor of this size, DPI of an image may be higher than 300 DPI which is visible to naked eyes, and also the diagnostic apparatus is small in size and low in price.

In addition, the image sensor 5 may further have an image signal processor (ISP) to enable a system on chip (SOC), so that the image sensor 5 and the SOC formed with the ISP may directly output images of high quality. Therefore, Complex circuits are not needed in the diagnostic apparatus to process images. This can also apparently reduce the size of the diagnostic apparatus. It should be noted that, an image sensor having an ISP may be used herein, and also an ISP may be disposed independently when an image sensor does not have an ISP.

The aspects of the present invention have the following advantages. First, the diagnostic apparatus uses multiple digital camera units each including an optics and an image sensor smaller than ⅓ inches, and therefore, the diagnostic apparatus has a small size and can be used as a portable device, for example, it may be used at home, so that a user may go to see a doctor in the hospital only when it is necessary. Second, multiple digital camera units may capture images of multiple reaction areas at a time (for example, multiple reaction areas of a pregnancy test strip or a blood glucose test strip), instead of capturing the images of only one reaction area at a time, so that images of different reaction areas do not need to be captured at multiple times. Therefore, the diagnostic apparatus can conduct rapid detection. Third, compared with a manner of using only one camera unit, multiple camera units improve dots per inch (DPI). In addition, because multiple camera units can be arranged evenly around multiple reaction areas, DPI and imaging quality of images of the reaction areas can be improved. Contrarily, if one camera unit is used, DPI of the photographed specimen is reduced, and according to imaging features of optical lens, an image of a reaction area close to the central position of the strip to be detected may be clear. However, the farther a reaction area is away from the central position, the worse the quality of images of the reaction area gets. Fourth, the diagnostic apparatus can capture an image of an entire reaction area, thereby providing more accurate and more comprehensive information of the reaction area. The diagnostic apparatus does not provide an average value of light intensities, but shows how light spreads over the reaction area, including providing the density of occult blood over the entire reaction area. This is favorable to applications where occult blood detection is needed. Fifth, a standard test strip (that is, reference color chart) needs to be inserted into an existing similar apparatus during detection to adjust white balance, but the standard test strip is not needed in the diagnostic apparatus of the present invention, and the diagnostic apparatus may be preset with a white balance parameter before sales.

### BRIEF DESCRIPTION OF THE DRAWINGS

Preferred embodiments of the present invention are described in detail below with reference to accompanying drawings, so that a technical person with ordinary skill in the art can understand more clearly the foregoing and other features and advantages of the present invention. In the accompanying drawings:

FIG. 1 is a schematic three-dimensional view according to an aspect of the present invention;

FIG. 2 is a side view according to the aspect of the present invention;

FIG. 3 is a front view of camera units and a specimen to be detected according to another aspect of the present invention;

FIG. 4 is a schematic exploded view of a camera unit according to another aspect of the present invention;

FIG. 5 is an inverted schematic three-dimensional view of the camera unit in FIG. 4; and

FIG. 6 is an erected schematic three-dimensional view of the camera unit in FIG. 5.

The accompanying drawings are marked as follows:

| Label | Part names |
|---|---|
| 1 | Digital camera unit |
| 2 | Test strip |
| 3 | Shell |
| 4 | Optics |
| 5 | Image sensor |
| 6 | Reflector |
| 7 | Printed circuit board |

### DETAILED DESCRIPTION OF THE INVENTION

To make the objectives, technical solutions and advantages of the present invention more clearly, the present invention is further described in detail below by using exemplary embodiments.

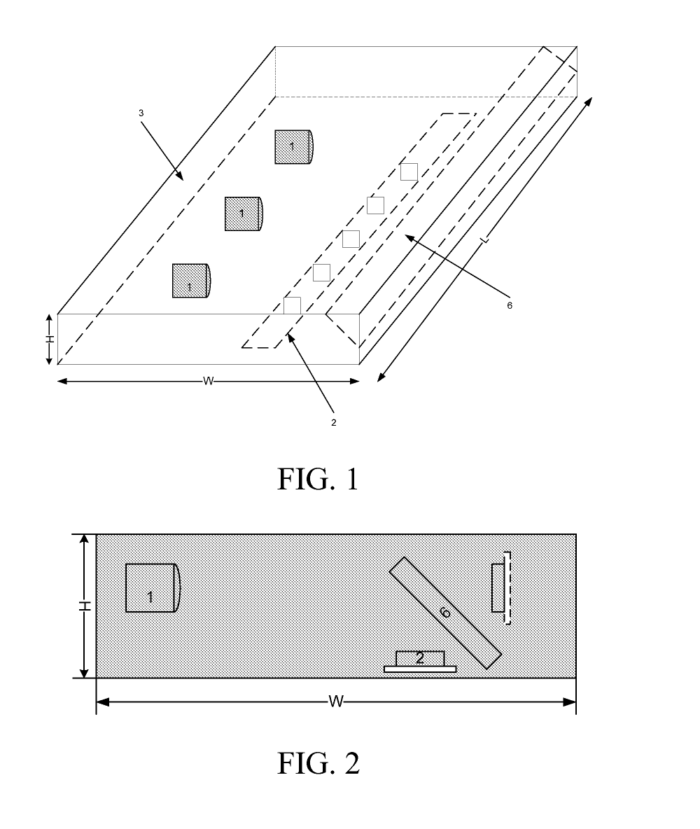

As shown in FIG. 1 to FIG. 3, an aspect of the present invention provides a diagnostic apparatus for capturing a medical image. The apparatus includes: a cavity for accommodating a medical specimen to be detected, a white light source (not shown), and multiple digital camera units 1 for capturing images of the specimen to be detected. The camera units each include a group of optics 4 with positive refractive power and an image sensor 5 smaller than ⅓ inches.

The cavity for accommodating a medical specimen to be detected may be in various structures. For example, it may be in a form of a passage, and a user inserts a medical specimen to be detected, for example, a test strip 2, into the passage, and then may use the diagnostic apparatus to detect the specimen. The cavity may also be in the form of a drawer having a sliding rail. When a medical specimen needs to be detected, the drawer is pulled out, the medical specimen to be detected is put in the drawer, and then detection may be performed after the drawer is pushed in. With such a drawer, a user may easily load the drawer with a medical specimen to be detected. Besides using a drawer type structure with a sliding rail, the cavity may also use a component that is movable relative to the diagnostic apparatus body or a shell 3, for example, a rotating mechanism may be used. The rotating mechanism is rotatable relative to the diagnostic apparatus body or the shell 3, so that when a specimen to be detected needs to be loaded, the rotating mechanism is rotated out from the diagnostic apparatus body or the shell 3, so as to facilitate loading the rotating mechanism with the specimen to be detected by a user.

In addition, it should be noted that, the diagnostic apparatus may be provided with only one cavity for accommodating a medical specimen to be detected, and does not need to be provided with another cavity for accommodating a standard specimen. In other words, when using the diagnostic apparatus, it is unnecessary to acquire an image of a standard specimen. When detecting a medical specimen, a standard test strip (that is, reference color chart) needs to be inserted into an existing similar apparatus to adjust white balance; however, the diagnostic apparatus may be preset with a white balance parameter before sales. The cavity shown in FIG. 1 to FIG. 3 is a cavity arranged horizontally along a lengthwise direction L of the diagnostic apparatus shown in the drawing, and a technical person skilled in the art should understand that the cavity may also be arranged along a longitudinal direction, or be arranged in, for example, in the shape of an arc.

The white light source that is not shown in the drawings is a full spectrum light source which casts its light on the medical specimen to be detected, and the light, after being reflected by the specimen to be detected, is then cast on a digital camera unit 1. The white light source applicable to the present invention may be an ordinary LED, and multiple semiconductor LEDs or a semiconductor LED with multiple colors is not needed. As a result, one aspect of the present invention is low in price and small in size. However, to cast the light on the rectangular specimen to be detected more evenly, two semiconductor LEDs may be used.

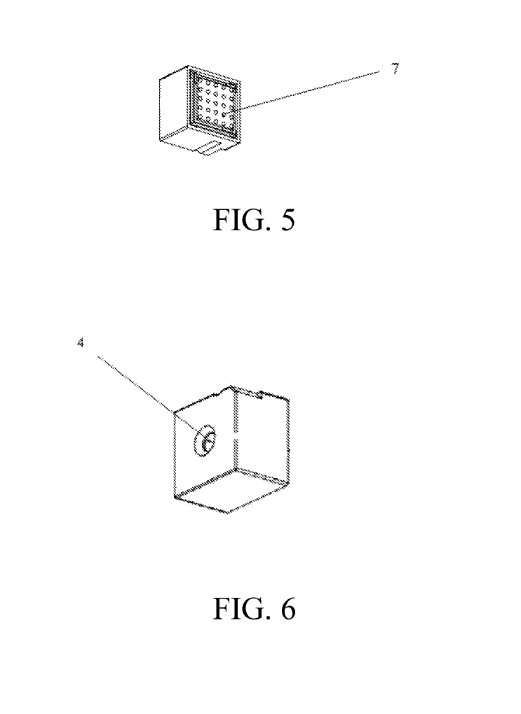

As shown in FIG. 4, FIG. 5, and FIG. 6, optics 4 are an assembly of multiple lenses that is fixed as a unit. Refractive power of an optical system is a numerical representation of convergence capability or divergence capability of an optical system, and if an optical system has a positive refractive power, it represents that the optical system can converge light. Preferably, the digital camera unit 1 uses a wafer-level camera (WLC). All components of a WLC are made on a wafer, and then an optical wafer is packaged together with an image-sensor wafer (for example, a complementary metal-oxide-semiconductor (CMOS) wafer). Compared with a traditional camera module, the thickness of the optics of a WLC is greatly reduced, a focusing process of the module is also saved, and a digital image can be directly generated. In addition, a WLC can be processed with a standardized packaging process, which is low in production cost and high in reliability.

As shown in FIG. 4 and FIG. 5, the WLC used as the digital camera unit 1 of an aspect of the present invention mainly includes a wafer-level image sensor 5 smaller than ⅓ inches and wafer-level optics (WLO) with positive refractive power 4. The use of the wafer-level image sensor 5 smaller than ⅓inches makes the diagnostic apparatus small in size, so that the diagnostic apparatus is easy to be carried and used. In addition, the cost of the diagnostic apparatus is also low. A small charge coupled device (CCD) or a CMOS image sensor may be used as the image sensor 5. For a urine test strip, a CMOS image sensor of 1/13 inches may be used, and by using an image sensor of such dimension, an image of an entire reaction area of test strips with multiple lengths can be captured, and images of quality meeting common detection requirements can be captured.

The WLO with positive refractive power is optical lens processed by a high-tech wafer-level packaging technology. A camera module made by the WLO process does not need focusing during a WLC packaging process, lens focusing process is reduced, and packaging may be performed directly on a through silicon via (TSV). Therefore, the TSV may be used to stack the WLO (optical wafer) and the wafer-level image sensor smaller than ⅓inches to make a digital camera unit of an even smaller size. The TSV is a new technical solution to conduct interconnections of stacked chips in a three-dimensional integrated circuit. The technology can make the density of chips stacked in a three-dimensional direction the greatest, interconnection lines between the chips the shortest and the appearance size the smallest, and can greatly accelerate speed of the chips with low power consumption. Compared with the traditional packaging, the TSV has characteristics such as a small pitch, multiple pins, and high connection reliability. The WLC and the processing technology thereof used in the present invention are all prior arts of the semiconductor field, and a WLC used as the digital camera unit 1 of the present invention may be acquired in the market, so that structures, performances and processing technologies of the WLC are not elaborated herein.

In addition, as shown in FIG. 4 to FIG. 6, a WLC may be connected to another relay circuit such as a PCB 7 or a flexible printed circuit board (FPC), so that the diagnostic apparatus is easily connected electrically. The CMOS sensor is disposed on a PCB, a solder ball (not shown) is disposed at the bottom of the WLC to solder the WLC on the PCB, and the PCB is below the solder ball.

In addition to WLO 4 with positive refractive power and the image sensor 5 smaller than ⅓ inches, the digital camera unit 1 may further include a support for fixing the WLO, and the WLO 4 may further include an optical filter, a baffle, and the like. These components are not shown in the drawings.

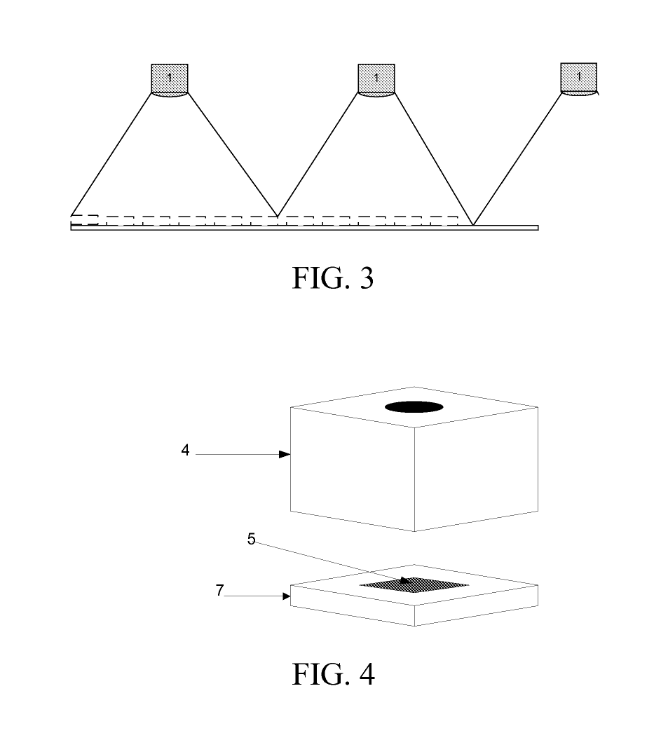

As shown in FIG. 1 and FIG. 2, to further reduce the size of the diagnostic apparatus, one or more reflectors 6 may be disposed to shorten the distance between the digital camera unit 1 and the specimen to be detected. A technical person skilled in the field of optics may design the number and locations of the reflectors according to ordinary optical knowledge. As shown in FIG. 1 and FIG. 2, one reflector is arranged, and the reflector is arranged at an inclination angle of conventional 45 degrees. It can be seen from FIG. 2 and FIG. 3 that, the image photographed by the digital camera unit 1 is a virtual image (a virtual image is represented by dotted lines in the drawing) of the medical specimen to be detected, formed by the reflector. An object distance is the distance between the digital camera unit 1 and the virtual image.

In addition, the diagnostic apparatus may further have a shell 3, so that the cavity, the white light source, and the digital camera unit 1 are all accommodated in the shell 3.

Specific structures and operation processes of an aspect of the diagnostic apparatus are briefly described below by using a urine test strip as an example and in combination with FIG. 1 to FIG. 3. A standard urine test strip is 11 cm. A cavity (not shown) for accommodating a specimen to be detected, of the diagnostic apparatus, is arranged horizontally along the lengthwise direction L of the diagnostic apparatus shown in FIG. 1. Therefore, the urine test strip in the cavity is also horizontal, and is not easily bent to affect quality of a captured image. The diagnostic apparatus has 3 digital camera units 1, and these digital camera units 1 are also arranged separately along the lengthwise direction L. The 3 digital camera units 1 separately capture images of different reaction areas of the urine test strip. As shown in FIG. 3, reaction areas covered by different digital camera units 1 desirably do not overlap with each other; otherwise, the detection result may be affected, and neighboring digital camera units 1 may overlap in blank areas of the urine test strip.

The diagnostic apparatus further has a reflector 6 which is arranged in a height H direction shown in FIG. 1 and inclines to 45 degrees. The three digital camera units 1 capture virtual images (in FIG. 3, dotted blocks represent virtual images of reaction areas of the urine test strip) of the urine test strip in the reflector. Using such a reflector, the entire width W of the diagnostic apparatus is approximate to the object distance, and the height H is approximate to the width of the urine test strip. The digital camera unit 1 departs from the urine test strip for a certain distance, for example, 50 mm, and the distance is the object distance (as shown in FIG. 2 and FIG. 3, the distance that the digital camera unit 1 departs from the virtual image of the urine test strip). To obtain a proper DPI (it is acceptable when it is visible for naked eyes, between 300 and 400) and better image quality, the relationship between the focal length of the optics 4 and the object distance meets the following requirements: the focal length of the optics divided by the corresponding object distance is smaller than 0.08. For example, when the object distance is 50 mm, the focal length of the optics may be about 1.2 mm.

The image sensor 5 may use a common VGA (DPI is 640×480) CMOS sensor of 1/13 inches. It should be noted that, the present invention does not have specific requirements for the DPI of the image sensor 5, and it is acceptable as long as a proper DPI is selected according to user's requirements for image quality. And the quality of an image obtained by such an image sensor 5 is sufficient to meet subsequent requirements of image analysis. For example, a captured image is RGB888 (24-bit color depth), which means that different colors of 16777216 gradients can be provided for subsequent analysis. The image of this quality is sufficient to analyze the density of occult blood.

In addition, the image sensor 5 may further have an ISP to form a so-called system on chip (SOC), so that the SOC formed by the image sensor 5 and the ISP may directly output images of high quality. Therefore, complex circuits do not need to be arranged in the diagnostic apparatus to process images. This can also apparently reduce the size of the diagnostic apparatus. A main effect of an ISP is to perform post-processing on the signals output by a front-end image sensor. The main functions of the ISP include linear correction, denoising, defective pixel removal, interpolation, automatic exposure control, and the like. An image sensor having an ISP may be used herein, and also an ISP may be disposed independently when an image sensor does not have an ISP.

The process of detecting a urine test strip by the diagnostic apparatus is briefly described below. The urine test strip is taken out of urine and then put in the cavity for accommodating a specimen to be detected. An image of the urine test strip is produced in the reflector 6, a virtual image is captured in the image sensor 5 through the optics 4 and is processed by the ISP, and then an image of high quality is output. The present invention does not relate to subsequent processing of an image, so that how to perform image processing is not elaborated herein.

It can be seen from the above that, by using a digital camera unit including optics 4 with positive refractive power and an image sensor 5 smaller than ⅓inches to capture directly images of a specimen to be detected, the present invention not only can make the diagnostic apparatus to provide detailed information of the specimen being detected, but also can reduce the size of the diagnostic apparatus. In addition, as the wafer level packaging technology may be used in manufacturing, performance of the digital camera unit is stable and the cost is extremely low.

The abovementioned is merely preferable embodiments of the present invention, but is not used to limit the present invention. Any modifications, equivalent replacements, and improvements made without departing from the spirit and principle of the present invention shall fall within the protection scope of the present invention.

What is claimed is:

1. A diagnostic apparatus for capturing a medical image, comprising:
a cavity for accommodating a medical specimen to be detected;
a white light source; and
multiple digital camera units for photographing the specimen to be detected, wherein the camera units each comprise optics with positive refractive power and an image sensor smaller than ⅓ inches.

2. The diagnostic apparatus according to claim 1, wherein the image sensor is a wafer-level image sensor.

3. The diagnostic apparatus according to claim 2, wherein the optics are wafer-level optics processed and formed by using a wafer-level packaging process.

4. The diagnostic apparatus according to claim 3, wherein the medical specimen to be detected is a urine test strip.

5. The diagnostic apparatus according to claim 4, wherein the number of the digital camera units is three, the three digital units are arranged in a lengthwise direction of the urine test strip, and a relationship between the focal length of the optics and an object distance meets the requirements that the focal length of the optics divided by the object distance is smaller than 0.08.

6. The diagnostic apparatus according to claim 1, wherein the white light source is one or more semiconductor light emitting diodes.

7. The diagnostic apparatus according to claim 1, further comprising one or more reflectors for turning optical paths to reduce the size of the diagnostic apparatus.

8. The diagnostic apparatus according to claim 1, wherein the digital camera unit further comprises a printed circuit board disposed below the image sensor.

9. The diagnostic apparatus according to claim 1, further comprising a shell, wherein the cavity, the light source and the digital camera units are all disposed in the shell.

10. The diagnostic apparatus according to claim 9, wherein the cavity is provided with a moving component that is movable relative to the shell, and the moving component can be moved out of the shell, so that a user can load the medical specimen to be detected on the moving component.

11. The diagnostic apparatus according to claim 1, wherein the image sensor is 1/13 inches.

12. The diagnostic apparatus according to claim 1, wherein the image sensor is further provided with an image signal processor.
